(19) United States
(12) Patent Application Publication
(10) Pub. No.: US 2011/0149399 A1
(43) Pub. Date: Jun. 23, 2011

(54) ANTI-REFLECTION STRUCTURE AND METHOD FOR FABRICATING THE SAME

(75) Inventors: Lung-Han Peng, Taipei City (TW); Han-Min Wu, Taipei City (TW)

(73) Assignee: NATIONAL TAIWAN UNIVERSITY, Taipei (TW)

(21) Appl. No.: 12/774,650

(22) Filed: May 5, 2010

(30) Foreign Application Priority Data
Dec. 18, 2009 (TW) TW098143607

(51) Int. Cl. G02B 1/11

(52) U.S. Cl. 359/580

(57) ABSTRACT

The embodiment provides an antireflection structure and a method for fabricating the same. The antireflection structure includes a substrate having a plurality of protruding structures adjacent to one another, thereby allowing light to transmit through. And a dielectric structural layer covers a plurality of the protruding structures.

### CROSS REFERENCE TO RELATED APPLICATIONS

This application claims priority of Taiwan Patent Application No. 98143607, filed on Dec. 18, 2009, the entirety of which is incorporated by reference herein.

### BACKGROUND OF THE INVENTION

1. Field of the Invention

The present invention relates to an antireflection structure and a method for fabricating the same, and in particular relates to an antireflection structure having a dielectric structural layer and a method for fabricating the same.

2. Description of the Related Art

Opto-electronic semiconductor devices are electrical-to-optical or optical-to-electrical power transducers that have great potential in the developments of environmentally-friendly green products. However, the opto-electronic semiconductor devices still suffer a severe problem as the high surface reflection occurring at device surfaces, thereby resulting in low electrical-to-optical or optical-to-electrical conversion efficiency. To solve the aforementioned problem, the conventional technology suggests an antireflection structure, which allows wideband and large-angle incident light to pass through the surface of the opto-electronic semiconductor device. As shown in FIG. 1, Professor Green in University of New South Wales, Australia uses inverted pyramid structures 100 to serve as surface antireflection structures on a passivated emitter rear locally diffused solar cell (PERL solar cell). However, the fabrication process of the inverted pyramid structures developed by Professor Green, is much complex and time-consumed, thereby a low chip yield is also expected. As a result, the PERL solar cell with inverted pyramid antireflection structures has a high cost and unit price, which is harmful for mass production and product application.

Thus, a novel antireflection structure and a method for fabricating the same are desired.

### BRIEF SUMMARY OF THE INVENTION

An exemplary embodiment of an antireflection structure and a method for fabricating the same are provided. The antireflection structure comprises: a substrate having a plurality of protruding structures adjacent to one another, thereby allowing light transmitting therein. A dielectric structural layer covers a plurality of the protruding structures.

An exemplary embodiment of a method for fabricating an antireflection structure comprises: providing a substrate. A patterning process is performed to form a plurality of protruding structures adjacent to one another, thereby allowing light to transmit through. A dielectric structural layer is entirely formed covering a plurality of the protruding structures.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of the conventional antireflection structure.

FIGS. 2-4 are cross sections showing fabrication of an exemplary embodiment of an antireflection structure of the invention.

FIGS. 5-6 are cross sections showing fabrication of another exemplary embodiment of an antireflection structure of the invention.

FIG. 7 shows the etching mechanism of an exemplary embodiment of an antireflection structure during performance of an etching process.

FIG. 8 shows measured normal reflectivities in different wavelengths of exemplary embodiments of an antireflection structure having a dielectric structural layer in various thicknesses.

FIG. 9 shows measured TE mode reflectivities versus tilted angles of exemplary embodiments of an antireflection structure having a dielectric structural layer in various thicknesses.

FIG. 10 shows measured TM mode reflectivities versus tilted angles of exemplary embodiments of an antireflection structure having a dielectric structural layer in various thicknesses.

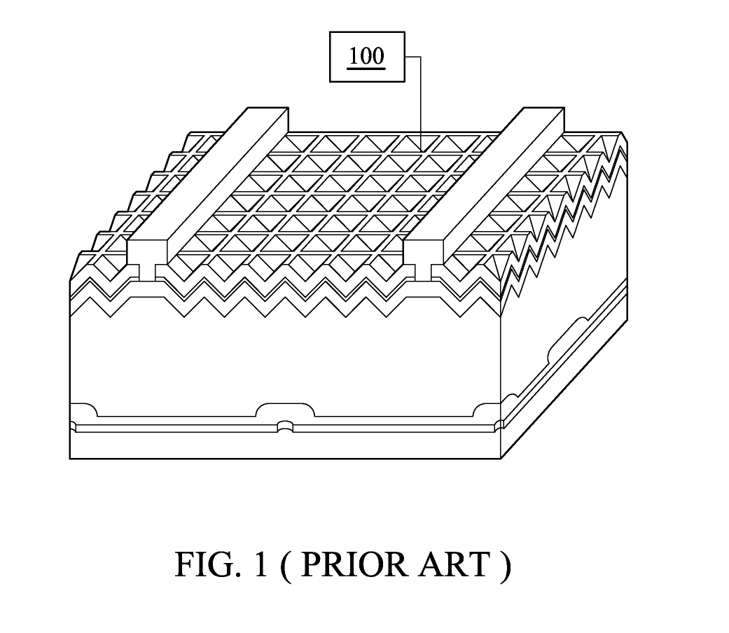

### DETAILED DESCRIPTION OF THE INVENTION

The following description is of a mode for carrying out the invention. Wherever possible, the same reference numbers are used in the drawings and the descriptions to refer the same or like parts. In the drawings, the size of some of the elements may be exaggerated and not drawn to scale for illustrative purposes. The dimensions and the relative dimensions do not correspond to the actual dimensions of the invention. This description is made for the purpose of illustrating the general principles of the invention and should not be taken in a limiting sense.

Exemplary embodiments of an antireflection structure and a method for fabricating the same are provided. The antireflection structure is fabricated by using a patterning process to form a lens array with a period smaller than a wavelength of the incident light on a semiconductor material substrate, wherein the lens array has a function of refractive index matching. Further, a dielectric structural layer with a dielectric constant between air and the substrate covers the lens array such that the effective refractive index of the antireflection structure has a gradient distribution. Therefore, the antireflection structure has superior antireflection ability.

FIGS. 2-4 are cross sections showing fabrication of an exemplary embodiment of an antireflection structure 500a of the invention. Referring to FIG. 2, a substrate 200 is provided. In one embodiment, the substrate 200 may comprise semiconductor materials, oxide or organic materials, wherein the semiconductor materials may comprise silicon or III-V semiconductors such as gallium nitride (GaN) or gallium arsenide (GaAs), and the oxide may comprise silicon dioxide (SiO₂), indium tin oxide (ITO) or zinc oxide (ZnO). Next, disposing at least one etching hard mask structure 201 comprising a plurality of spherical features 202 adjacent to one another on the substrate 200. In one embodiment, the spherical features 202 may be dispersed in a solution such as methyl alcohol. Next, the spherical features 202 may be laminated on a surface of the substrate 200 by methods of spin coating, standing vaporization or suspension and scooping up. Therefore, the laminated spherical features 202 may be referred to as self-assembled particles. In one embodiment, the spherical features 202 may be laminated as a single layer. Alternatively, the spherical features 202 may be laminated as multi layers, but not limited herein. As shown in FIG. 2, in one embodiment, the spherical features 202 may be in a close-packed arrangement (such as a hexagonal close-packed (HCP) arrangement). The spherical features 202 may have a diameter d, which may be selectively lower than a wavelength of the light incident into the result antireflection structure. Alternatively, the spherical features 202 may be in a non-close-packed (ncp) arrangement, but not limited herein. Additionally, in one embodiment, the spherical features 202 may comprise polystyrene (PS).

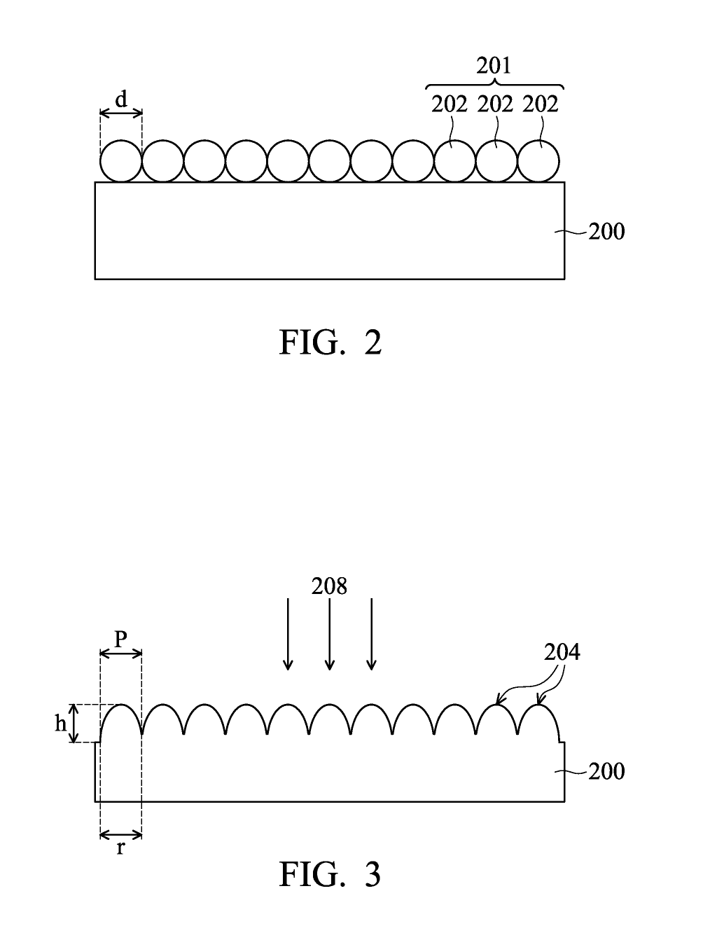

Next, referring to FIG. 3, an anisotropic etching process such as reactive ion etching (RIE) is performed to remove a portion of the substrate 200 not covered by at least one of the etching hard mask structures 201 as shown in FIG. 2, thereby forming a plurality of protruding structures 204 adjacent to one another.

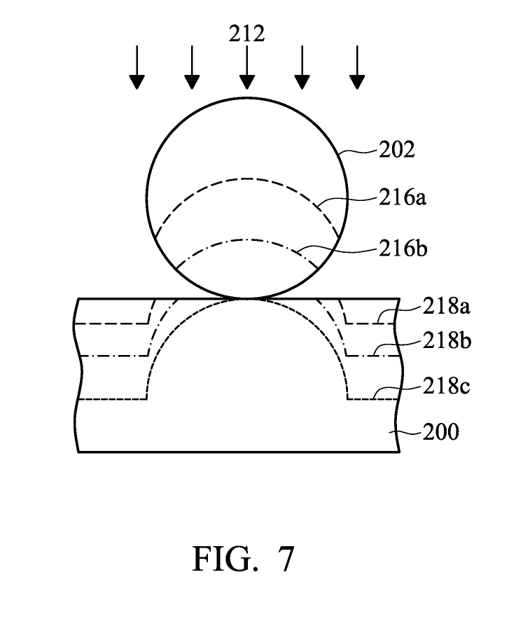

Note that not only the substrate 200 is removed, but also the etching hard mask structure 201 is removed during the anisotropic etching process. Also, the volume of the etching hard mask structure 201 is gradually shrunk and eventually disappears while the etch time is increasing in the anisotropic etching process. Because the volume of the etching hard mask structure 201 composed by the spherical features 202 shrinks gradually, the effective area of the substrate treated with reactive etchant gradually increases. FIG. 7 shows the etching mechanism of an exemplary embodiment of an antireflection structure during performing an etching process 212. As shown in FIG. 7, dotted lines 216a and 216b show surface profiles of the spherical features 202 in different etch times, and dotted lines 218a to 218c show surface profiles of the substrate 200 at corresponding etch times. The exposed region of the substrate 200 is etched with a deeper depth for a longer time in the etching process. The etching process is performed until at least one the etching hard mask structure 210 is totally removed. The dotted line 218c shows the surface profile of the substrate 200 while the spherical features 202 are totally removed.

After performing the etching process, the surface profile of the etching hard mask structure 201 is transported to the substrate 200, thereby forming a plurality of protruding structures 204 adjacent to one another, thereby allowing light 208 to transmit through. As shown in FIG. 3, in one embodiment, the protruding structure 204 may have a period p substantially equal to the diameter d of the spherical features 202. Also, the period p of the protruding structures 204 may be selected to be smaller than the wavelength of the light 208. Therefore, the protruding structures 204 may be referred to as a sub-wavelength structure. Further, the protruding structures 204 are formed by using the spherical features 202 arranged in an array as an etching hard mask. Therefore, the protruding structures 204 may also serve as a sub-wavelength lens array. As shown in FIG. 2, in one embodiment, the etching activation of the etching hard mask structure 201 is changed with various etchants during the etching process. The protruding structures 204, however, may substantially be symmetric structures. For example, the protruding structures 204 may be symmetric lens structures having a shape comprising aspheric lens shape, spherical lens shape, parabolic lens shape, pyramidical lens shape, pyramidical pillar lens shape, corner pillar lens shape, corn shaped lens shape or circular pillar lens shape. Although the protruding structures 204 may have other symmetric lens structures, but not limited herein. The aspheric lens means that a structure with a cross section of a non-perfect spherical surface has a non-perfect curved gradient, which thereby facilitates light focusing at one point and eliminates aberration and distortion. As shown in FIG. 3, in one embodiment, the protruding structures 204 may have a height h and a bottom diameter r, wherein the height h to the bottom diameter r is equal to a ratio of between about 0.2 and 40, preferably of 1. Alternatively, the protruding structures 204 may be formed by masks using photolithography/etching processes, or by an electron-beam direct writing process or light beam interference lithography process, but not limited herein.

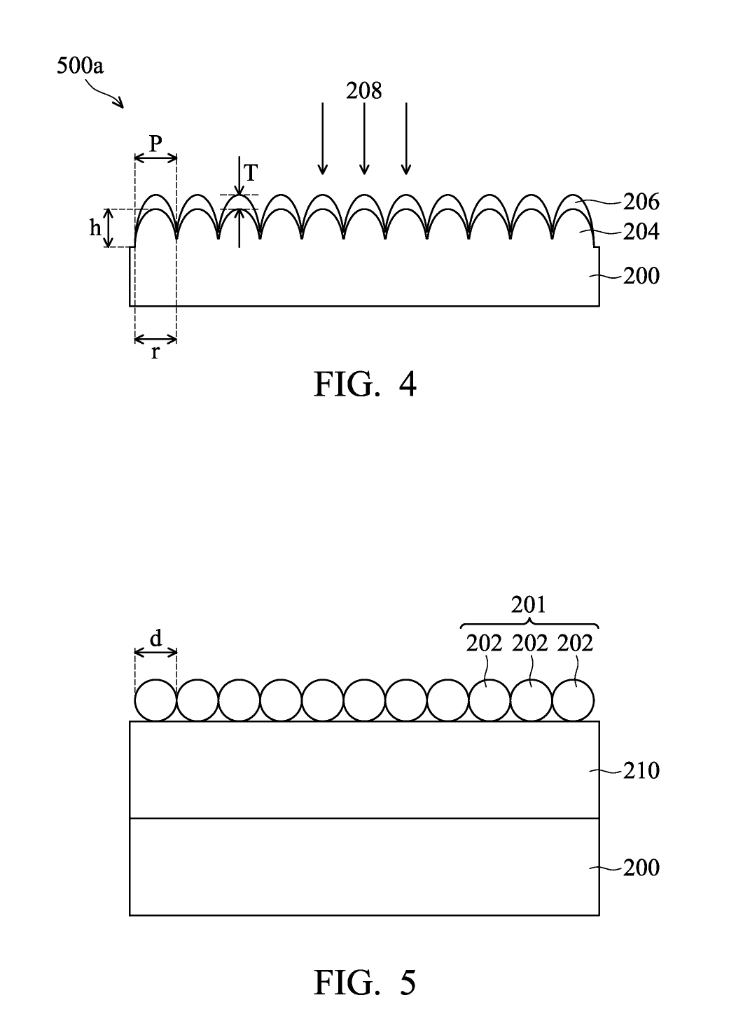

Next, referring to FIG. 4, a dielectric structural layer 206 may entirely cover the protruding structures 204 by using methods of thermal evaporation, reactive sputtering, magnetron sputtering, electron-gun evaporation, atomic layer deposition (ALD), chemical vapor deposition (CVD), atmosphere chemical vapor deposition (APCVD), metal-organic chemical vapor deposition (MOCVD), molecular beam epitaxy (MBE), wet thermal oxidation, dry thermal oxidation or annealing. An exemplary embodiment of an antireflection structure 500a of the invention is completely formed. In one embodiment, a thickness T of the dielectric structural layer 206 may be properly selected such that the thickness T of the dielectric structural layer 206 to the bottom diameter r of the protruding structures 204 is equal to a ratio of between 0.01 and 10. In one embodiment, materials of the dielectric structural layer 206 may be properly selected such that a dielectric constant of the dielectric structural layer 206 is between a dielectric constant of air (equal to 1) and a dielectric constant of the substrate 200 (For example, the dielectric constant of a silicon substrate is about 4). Therefore, the effective refractive index of the antireflection structure 500a may have a gradient distribution to eliminate reflected light generation. Additionally, the formation of the dielectric structural layer 206 may increase the filing factor of the antireflection structure 500a indirectly (the filing factor is a ratio of an area of the protruding structures 204 covered by the dielectric structural layer 206 to the total area of the substrate 200). In addition, the dielectric structural layer 206 may fill holes and defects of the protruding structures 204 such that a surface of the protruding structures 204 is close to that of a smooth lens. As a result, the antireflection effect is further improved. For example, the dielectric structural layer 206 may comprise silicon dioxide, titanium dioxide, indium oxide, gallium oxide, zinc oxide (ZnO), tin oxide, aluminum oxide, indium tin oxide (ITO) or copper oxide. In this embodiment, the dielectric structural layer 206 may be metal oxides comprising ITO or ZnO (dielectric constant is about 2).

In one embodiment, the dielectric structural layer 206 may be just a single dielectric structural layer as shown in FIG. 4. Alternatively, the dielectric structural layer 206 may be a multi-layered dielectric structural layer, such that the effective refractive index of the formed antireflection structure 500a has smoother gradient distribution. In one embodiment, the dielectric structural layer 206 such as a multi-layered dielectric structural layer may comprise two to thirty dielectric layers, wherein the dielectric layers have the same dielectric constant, or the dielectric constants of the each dielectric layer increase from top (a terminal close to air) to bottom (a terminal close to the substrate 200) of the dielectric structural layer 206. Alternatively, the dielectric structural layer 206 may be constructed by a plurality of dielectric layer sets, and each of the dielectric layer sets comprises a plurality of dielectric layers, wherein the dielectric layers of the each dielectric layer set have dielectric constants increasing from top (a terminal close to air) to bottom (a terminal close to the substrate 200) of the dielectric structural layer 206. Therefore, in one embodiment of the dielectric structural layer 206 constructed by a plurality of dielectric layer sets, the dielectric constant of the dielectric structural layer 206 is in a periodic array arrangement.

In other embodiments, an annealing process may be performed after forming the dielectric structural layer 206. A fabrication method such as RIE used to form the protruding structures 204 may cause a lot of defects on the surface of the protruding structures 204. Therefore, when the antireflection structure 500a is used as an opto-electronic device (such as an opto-electronic semiconductor device), the defects may capture current carriers to form an electric field suppressing the current transmission. The annealing process may generate a surface passivation on the surfaces of the protruding structures 204 to fill the defects on the surfaces of the protruding structures 204 effectively, thereby reducing the defect density and the current carrier capture possibility. Therefore, the structure 500a has improved antireflection performances. Additionally, when the dielectric structural layer 206 comprises metal oxides, the annealing process facilitates the dielectric structural layer 206 and the substrate 200 transforming the alloy state. Therefore, the contact resistance or conductive resistance of the dielectric structural layer 206 to the substrate 200 can be reduced for better electrical connection. When the antireflection structure 500a is used on an opto-electronic device (such as an opto-electronic semiconductor device), the current signals may be transferred more effectively, thereby improving the device performances.

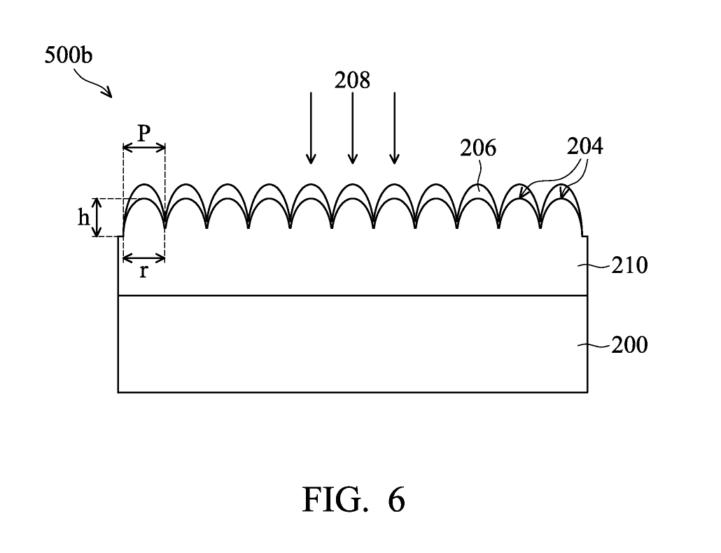

FIGS. 5-6 are cross sections showing fabrication of another exemplary embodiment of an antireflection structure 500b of the invention. Elements of the embodiments hereinafter, that are the same or similar as those previously described with reference to FIGS. 2-4 and 7, are not repeated for brevity. The difference between the antireflection structures 500a and 500b is that the antireflection structure 500b has the protruding structures 204 formed by patterning an insulating layer 210 deposited on a substrate 200. As shown in FIG. 5, an insulating layer 210 may be deposited on the substrate 200. In one embodiment, the insulating layer 210 and the substrate 200 may have the same semiconductor materials, oxide or organic materials, wherein the semiconductor materials may comprise silicon or III-V semiconductors such as gallium nitride (GaN) or gallium arsenide (GaAs), and the oxide may comprise silicon dioxide (SiO₂), indium tin oxide (ITO) or zinc oxide (ZnO). Next, at least one etching hard mask structure 201 comprising a plurality of adjacent spherical features 202 is disposed on the insulating layer 210.

Next, referring to FIG. 6, an anisotropic etching process such as reactive ion etching (RIE) is performed to remove a portion of the insulating layer 210 not covered by at least one of the etching hard mask structures 201 as shown in FIG. 2, thereby forming a plurality of protruding structures 204 adjacent to one another on the substrate 200. Next, a dielectric structural layer 206 may entirely cover the protruding structures 204 by using methods of thermal evaporation, reactive sputtering, magnetron sputtering, electron-gun evaporation, atomic layer deposition (ALD), chemical vapor deposition (CVD), atmosphere chemical vapor deposition (APCVD), metal-organic chemical vapor deposition (MOCVD), molecular beam epitaxy (MBE), wet thermal oxidation, dry thermal oxidation or annealing. Another exemplary embodiment of an antireflection structure 500b of the invention is completely formed. Similar to the antireflection structure 500a, an annealing process may be performed after forming the dielectric structural layer 206 of the antireflection structure 500b. Similar to the antireflection structure 500a, the protruding structures 204 of the antireflection structure 500b may have a height h and a bottom diameter r, wherein the height h to the bottom diameter r is equal to a ratio of between about 0.2 and 40, preferably of 1. Similar to the antireflection structure 500a, the a thickness T of the dielectric structural layer 206 of the antireflection structure 500b may be properly selected such that the thickness T of the dielectric structural layer 206 to the bottom diameter r of the protruding structures 204 is equal to a ratio of between 0.01 and 10.

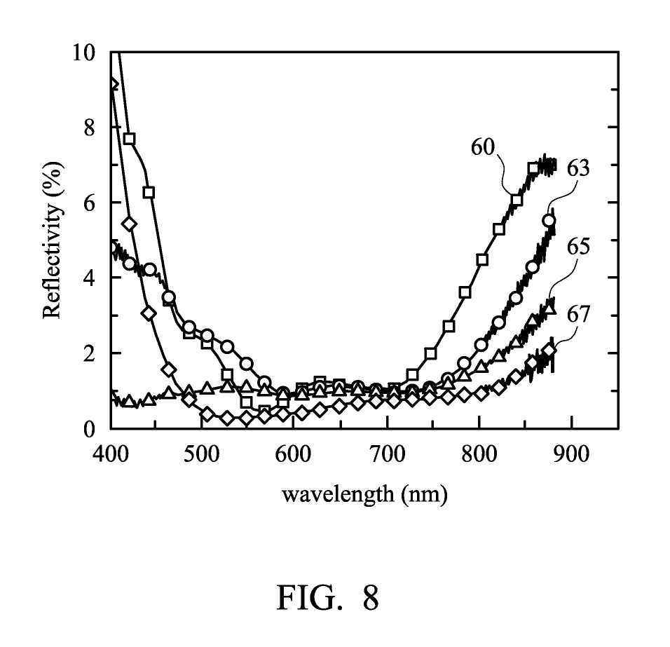

FIG. 8 shows measured normal reflectivities (That is, light is incident from directly above the antireflection structure) in different wavelengths of exemplary embodiments of an antireflection structure having a dielectric structural layer in various thicknesses. FIG. 8 shows the measurement result of the antireflection structure 500a fabricated as shown in FIG. 2-4, wherein the antireflection structure 500a uses a plurality of PS spherical features 202, which have a diameter of about 0.35 μm and are arranged in a close-packed signal layer, serving as an etching hard mask structure 201 to form protruding structures 204 having a height h of about 0.22 μm and a bottom diameter r of about 0.35 μm (the height to bottom diameter ratio is equal to about 0.63). Confirmed by the atomic force microscopy measurement, the protruding structures 204 are parabolic lens shaped. A ZnO dielectric structural layer 206 with various thicknesses may be formed on the protruding structures 204. As shown in FIG. 8, the antireflection structure 500a without the ZnO dielectric structural layer 206 deposited thereon (labeled as a curve 60) has a sudden increased normal reflectivity in short wavelengths and infrared ray regions. The antireflection structure 500a with the increased thickness of the ZnO dielectric structural layer 206, for example, the ZnO dielectric structural layer 206 of about 30 nm (labeled as a curve 63) and 50 nm (labeled as a curve 65), deposited thereon has a decreased normal reflectivity in short wavelengths and infrared ray regions. Especially, the antireflection structure 500a having a 50 nm ZnO dielectric structural layer 206 (labeled as a curve 65), the antireflection structure 500a has a normal reflectivity lower than 1% in 400-750 nm wavelength region and results in superior antireflection properties. Additionally, when the antireflection structure 500a having a 70 nm ZnO dielectric structural layer 206 (labeled as a curve 67), the antireflection structure 500a also has a normal reflectivity lower than 1% in 450-800 nm wavelength region. From the results as shown in FIG. 8, exemplary embodiments of an antireflection structure have improved antireflection properties due to a dielectric structural layer covering thereon.

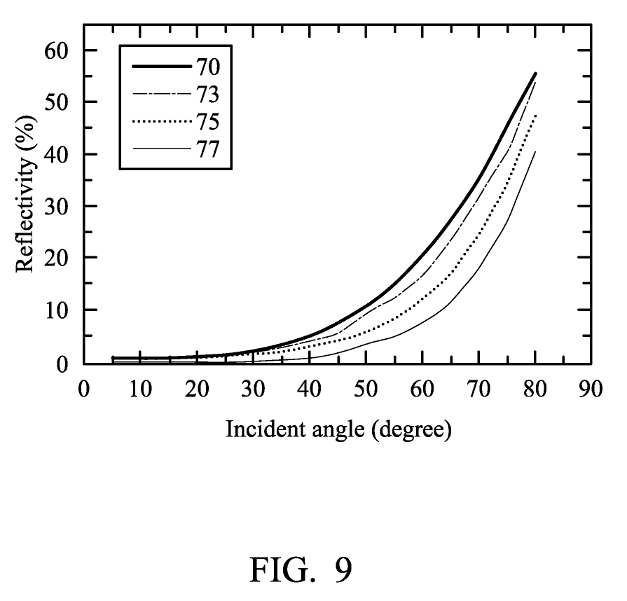

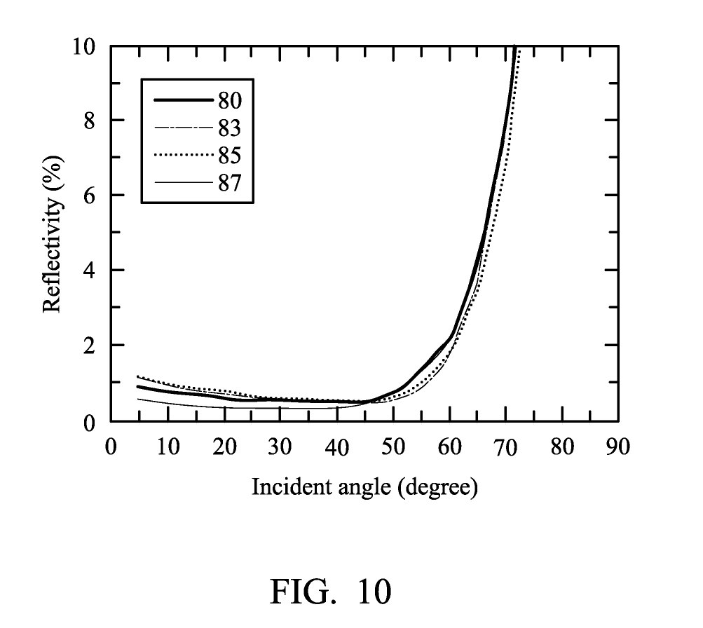

FIG. 9 shows measured transverse electric (TE) mode (a mode whose electric field vector is normal to the direction of propagation) reflectivities versus tilted angles of exemplary embodiments of an antireflection structure having a dielectric structural layer 206 in various thicknesses. FIG. 10 shows measured transverse magnetic (TM) mode (a mode whose magnetic field vector is normal to the direction of propagation) reflectivities versus tilted angles of exemplary embodiments of an antireflection structure having a dielectric structural layer 206 in various thicknesses. FIGS. 9-10 shows measurement results of the antireflection structure 500a having various thicknesses fabricated as shown in FIG. 2-4 by using a light source of a 632 nm wavelength He—Ne laser beam incident in different angles. As shown in FIG. 9, the antireflection structure 500a with the ZnO dielectric structural layer 206 of about 30 nm (labeled as a curve 73), 50 nm (labeled as a curve 75) and 70 nm (labeled as a curve 77) deposited thereon has the TE mode reflectivities smaller than the antireflection structure 500a without the ZnO dielectric structural layer 206 deposited thereon (labeled as a curve 70). When the tilted angle of the light source is smaller than 30 degrees, the TE mode reflectivities of the antireflection structure 500a with the ZnO dielectric structural layer 206 in various thicknesses are smaller than 2.5%. As shown in FIG. 10, the antireflection structure 500a without the ZnO dielectric structural layer 206 deposited thereon (labeled as a curve 80) and the antireflection structure 500a with the ZnO dielectric structural layer 206 of about 30 nm (labeled as a curve 83), 50 nm (labeled as a curve 85) and 70 nm (labeled as a curve 87) deposited thereon have similar TM mode reflectivity results, and have TM mode reflectivities lower than 1% when the tilted angle of the light source is smaller than 45 degrees. From the aforementioned measurement results, exemplary embodiments of an antireflection structure have superior antireflection ability for the large angle and in wire band incident light.

Exemplary embodiments of antireflection structures 500a and 500b comprises a plurality of the protruding structures 204 with a dielectric structural layer 206 of a proper thickness formed thereon to increase a ratio of the height to the bottom diameter of the protruding structures 204 of the antireflection structures 500a and 500b additionally, thereby improving the antireflection ability thereof. Also, the dielectric constant of the dielectric structural layer 206 is selected between the dielectric constant of air and the dielectric constant of the substrate 200 such that the effective refractive index of the antireflection structures 500a and 500b may have a smooth gradient distribution to eliminate reflected light generation. Also, the reflectivity of the antireflection structure 500a decreases. Compared with the conventional antireflection structure having a height-to-bottom diameter ratio dominated only by the protruding structures directly formed thereon, the antireflection structures 500a and 500b have a simple fabrication process, thereby facilitating mass production and reducing the fabrication cost.

While the invention has been described by way of example and in terms of the embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antireflection structure, comprising:
a substrate having a plurality of protruding structures adjacent to one another, thereby allowing light to transmit therein; and
a dielectric structural layer covering a plurality of the protruding structures.

2. The antireflection structure as claimed in claim 1, wherein a plurality of the protruding structures is a portion of the substrate.

3. The antireflection structure as claimed in claim 1, wherein a plurality of the protruding structures is disposed on the substrate.

4. The antireflection structure as claimed in claim 1, wherein a plurality of the protruding structures is arranged in an array with a period smaller than a wavelength of the light.

5. The antireflection structure as claimed in claim 1, wherein a plurality of the protruding structures have a shape comprising aspheric lens shape, spherical lens shape, parabolic lens shape, pyramidical lens shape, pyramidical pillar lens shape, corner pillar lens shape, corn shaped lens shape or circular pillar lens shape.

6. The antireflection structure as claimed in claim 1, wherein a plurality of the protruding structures has a height and a bottom diameter, wherein the height to the bottom diameter is equal to a ratio of between 0.2 and 40.

7. The antireflection structure as claimed in claim 1, wherein a thickness of the dielectric structural layer to the bottom diameter is equal to a ratio of between 0.01 and 10.

8. The antireflection structure as claimed in claim 1, wherein a dielectric constant of the dielectric structural layer is between a dielectric constant of air and a dielectric constant of the substrate.

9. The antireflection structure as claimed in claim 1, wherein the dielectric structural layer comprises a single dielectric structural layer or a multi-layered dielectric structural layer.

10. The antireflection structure as claimed in claim 9, wherein the multi-layered dielectric structural layer comprises two to thirty dielectric layers.

11. The antireflection structure as claimed in claim 9, wherein the dielectric layers have dielectric constants increasing from top to bottom of the dielectric structural layer.

12. The antireflection structure as claimed in claim 9, wherein the multi-layered dielectric structural layer comprises a plurality of dielectric layer sets.

13. A method for fabricating an antireflection structure, comprising:
providing a substrate;
performing a patterning process to form a plurality of protruding structures adjacent to one another, thereby allowing light transmitting therein; and
entirely forming a dielectric structural layer covering the protruding structures.

14. The method for fabricating an antireflection structure as claimed in claim 13, wherein performing the patterning process further comprising:
disposing at least one etching hard mask structure comprising a plurality of adjacent spherical features on the substrate; and
performing an etching process to remove at least one of the etching hard mask structures and a portion of the substrate not covered by at least one of the etching hard mask structures until at least one the etching hard mask structures is totally removed.

15. The method for fabricating an antireflection structure as claimed in claim 14, wherein the material of the adjacent spherical features is polystyrene or silicon oxide.

16. The method for fabricating an antireflection structure as claimed in claim 13, wherein a plurality of the protruding structures is arranged in an array with a period smaller than a wavelength of the light.

17. The method for fabricating an antireflection structure as claimed in claim 13, wherein a plurality of the protruding structures have a shape comprising aspheric lens shape, spherical lens shape, parabolic lens shape, pyramidical lens shape, pyramidical pillar lens shape, corner pillar lens shape, corn shape lens shape or circular pillar lens shape.

18. The method for fabricating an antireflection structure as claimed in claim 13, wherein a plurality of the protruding structures has a height and a bottom diameter, wherein the height to bottom diameter ratio is between 0.2 and 40.

19. The method for fabricating an antireflection structure as claimed in claim 13, wherein a thickness of the dielectric structural layer to the bottom diameter is equal to a ratio of between 0.01 and 10.

20. The method for fabricating an antireflection structure as claimed in claim 19, wherein the dielectric structural layer comprises a single dielectric structural layer or a multi-layered dielectric structural layer.
